(19) United States
(12) Patent Application Publication
(10) Pub. No.: US 2016/0061978 A1
(43) Pub. Date: Mar. 3, 2016

(54) SYSTEM AND METHOD FOR ATTENUATING MULTIPLE ENERGY IN SEISMIC DATA

(71) Applicant: Yves Dansereau, Calgary (CA)

(72) Inventor: Yves Dansereau, Calgary (CA)

(73) Assignee: CHEVRON U.S.A. INC., San Ramon, CA (US)

(21) Appl. No.: 14/468,561

(22) Filed: Aug. 26, 2014

(51) Int. Cl. G01V 1/36; G01V 1/28

(52) U.S. Cl. CPC G01V 1/364; G01V 1/28; G01V 1/38

(57) ABSTRACT

A method for processing seismic data contaminated by peg-leg multiple energy may include identifying at least one peg-leg event in the seismic dataset; flattening the seismic dataset on the peg-leg event; transposing the seismic dataset so that an axis representative of the geographic space becomes the first axis; filtering the transposed seismic dataset with a low-cut filter along the first axis; and transposing the filtered seismic dataset back to its original orientation. The method may be carried out on a computer system including a processor configured to execute modules implementing the method.

### FIELD OF THE INVENTION

The present invention relates generally to methods and systems for attenuating multiple energy in seismic data and, in particular, methods and systems for attenuating peg-leg multiples in seismic data.

### BACKGROUND OF THE INVENTION

In the field of exploration geophysics, seismic data is typically recorded through the use of active seismic sources, such as air guns, vibrator units, or explosives, and receivers, such as hydrophones or geophones. The sources and receivers may be arranged in many configurations. Typically, a seismic survey is designed to optimize the source and receiver configurations so that the recorded seismic data may be processed to locate and/or analyze subsurface geological features of interest such as hydrocarbon reservoirs.

Recorded seismic data is useful for identifying structural features of the subsurface but in many instances it is contaminated with energy that has reflected from multiple reflection surfaces, often called “multiples.” Multiples may be surface-related, meaning that the energy reflected at the free-surface and may include water-bottom multiples in which the energy reflected between the water bottom and the water surface, or peg-leg multiples wherein the energy reflected within the layers of the subsurface. Conventional methods exist that can attenuate surface-related multiples but peg-leg multiples are notoriously difficult.

There is a need for seismic processing methods that can attenuate peg-leg multiple energy so that hydrocarbon reservoirs may be identified and produced in an efficient and economical way.

### SUMMARY OF THE INVENTION

Described herein are implementations of various approaches for a computer-implemented method for seismic processing of a subsurface volume of interest.

A computer-implemented method for processing a seismic dataset contaminated with peg-leg multiple energy representative of a subsurface volume of interest includes identifying at least one peg-leg event in the seismic dataset; flattening the seismic dataset on the peg-leg event; transposing the seismic dataset so that an axis representative of the geographic space becomes the first axis to generate a transposed seismic dataset; filtering the transposed seismic dataset with a low-cut filter along the first axis to generate a filtered seismic dataset; and transposing the filtered seismic dataset to the original orientation to obtain a multiple-attenuated seismic dataset.

In another embodiment, a computer system including a data source or storage device, at least one computer processor, and a user interface used to implement the method for processing a seismic dataset representative of a subsurface volume of interest is disclosed.

In yet another embodiment, an article of manufacture including a non-transitory computer readable medium having computer readable code on it, the computer readable code being configured to implement a method for processing a seismic dataset representative of a subsurface volume of interest is disclosed.

The above summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

These and other features of the present invention will become better understood with regard to the following description, claims and accompanying drawings where:

FIG. 1 is a diagram of seismic energy traveling through the subsurface of the earth;

FIG. 2 is a flowchart of an embodiment of the present invention;

FIG. 3 is an example of a step of the present invention;

FIG. 4 is an example of another step of the present invention;

FIGS. 5A-5C represent an example of an intermediate result of the present invention;

FIGS. 6A-6C represent an example of a result of the present invention;

FIGS. 7A-7C represent an example of a result of the present invention; and

FIG. 8 schematically illustrates a system for performing a method in accordance with an embodiment of the invention.

### DETAILED DESCRIPTION OF THE INVENTION

The present invention may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present invention may be coded in different languages for application in a variety of computing platforms, environments, and architectures. It will be appreciated that the scope and underlying principles of the present invention are not limited to any particular computer software technology.

Moreover, those skilled in the art will appreciate that the present invention may be practiced using any one or combination of hardware and software configurations, including but not limited to a system having single and/or multiple processor computers, hand-held devices, tablet devices, programmable consumer electronics, mini-computers, mainframe computers, and the like. The invention may also be practiced in distributed computing environments where tasks are performed by servers or other processing devices that are linked through one or more data communications network. In a distributed computing environment, program modules may be located in both local and remote computer storage media including memory storage devices.

Also, an article of manufacture for use with a computer processor, such as a CD, pre-recorded disk or other equivalent devices, may include a tangible computer program storage medium and program means recorded thereon for directing the computer processor to facilitate the implementation and practice of the present invention. Such devices and articles of manufacture also fall within the spirit and scope of the present invention.

Referring now to the drawings, embodiments of the present invention will be described. The invention can be implemented in numerous ways, including, for example, as a system (including a computer processing system), a method (including a computer implemented method), an apparatus, a computer readable medium, a computer program product, a graphical user interface, a web portal, or a data structure tangibly fixed in a computer readable memory. Several embodiments of the present invention are discussed below. The appended drawings illustrate only typical embodiments of the present invention and therefore are not to be considered limiting of its scope and breadth.

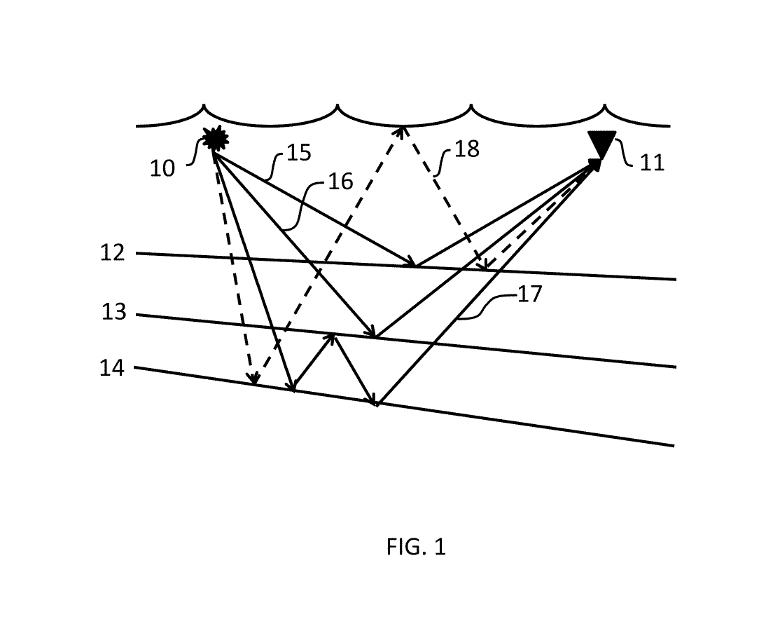

The present invention relates to attenuating peg-leg multiple energy in recorded seismic data. Peg-leg multiple energy is illustrated in FIG. 1. In FIG. 1, a source 10 emits seismic energy that is reflected at the water bottom 12 and subsurface reflectors 13 and 14. The seismic energy is recorded at receiver 11. Seismic energy that follows raypath 15 represents the reflection from the water bottom 12. Seismic energy that follows raypath 16 represents a primary reflection from reflector 13. Seismic energy following raypath 17 is peg-leg multiple energy; it reflects from reflector 14, then reflector 13 and again from reflector 14 before it reaches the receiver 11. The dashed-line raypath 18 illustrates a peg-leg multiple that has reflected at reflector 14, then reflected from the water surface (a free surface), and finally reflected from the water bottom 12 before being recorded at receiver 11. These examples are not meant to be limiting. The peg-leg multiple energy can reflect from any subsurface reflectors in any order, and can also reflect from the water bottom or free surface (interface at the air). In addition, the present invention is not limited to marine seismic data so there need not be a water bottom reflector. The seismic dataset will be oriented with a first axis representative of time or depth and at least one other axis representative of geographical space, which, by way of example and not limitation, could be source location, receiver location, and/or midpoint location. The seismic dataset may also have a geographical space axis that represents the distance between the sources and receivers, such as offset and/or angle. Those skilled in the art will be aware that the terms peg-leg multiple energy and peg-leg multiple event(s) are often used interchangeably and may be referred to as simply “peg-leg multiples” or even just “peg-legs”.

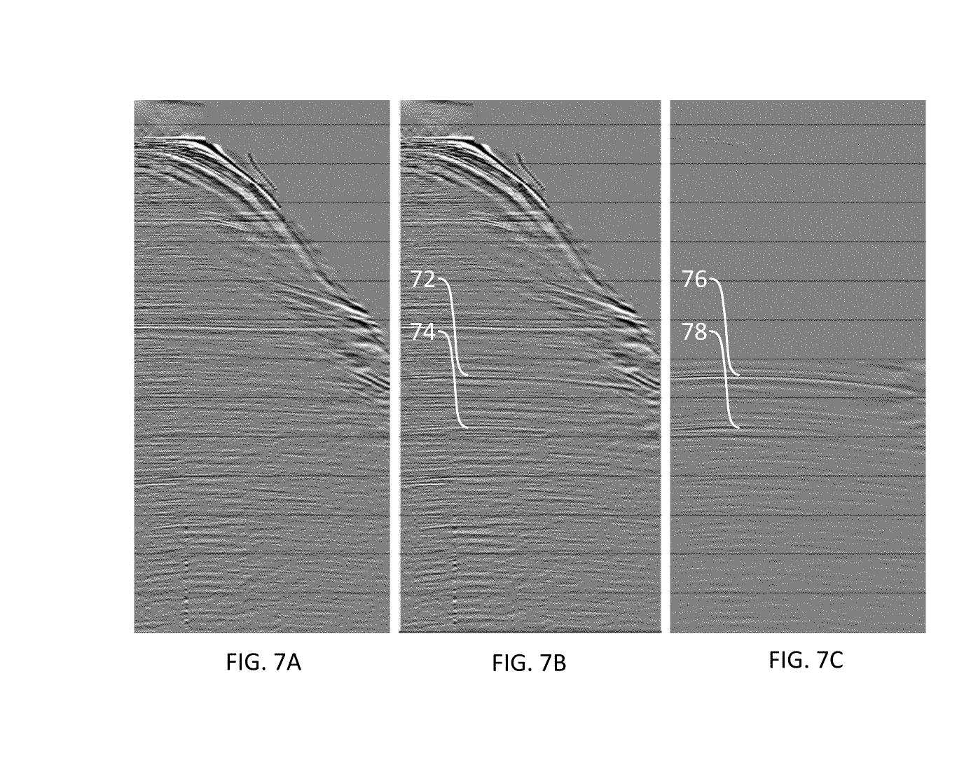

The peg-leg multiple energy is difficult to attenuate using conventional techniques. One reason for this difficulty is that the peg-leg energy appears as apex-shifted multiples in the recorded seismic data. This means that, when viewing the common-reflection-point, common-depth-point, or common-midpoint (CRP, CDP, or CMP) gathers, the multiple energy appears as a hyperbola with an apex that does not occur at zero-offset or zero-angle. This may be seen in FIG. 7B which is a CRP gather (vertical axis is time, horizontal axis is offset) including peg-leg multiple events 72 and 74. The left edge of FIG. 7B is zero-offset and the apexes of the peg-leg multiple events 72 and 74 are approximately where the call-out lines touch the events. The present invention provides a way to attenuate this peg-leg multiple energy in recorded seismic data so that the data is more useful for identifying subsurface geologic features such as hydrocarbon reservoirs.

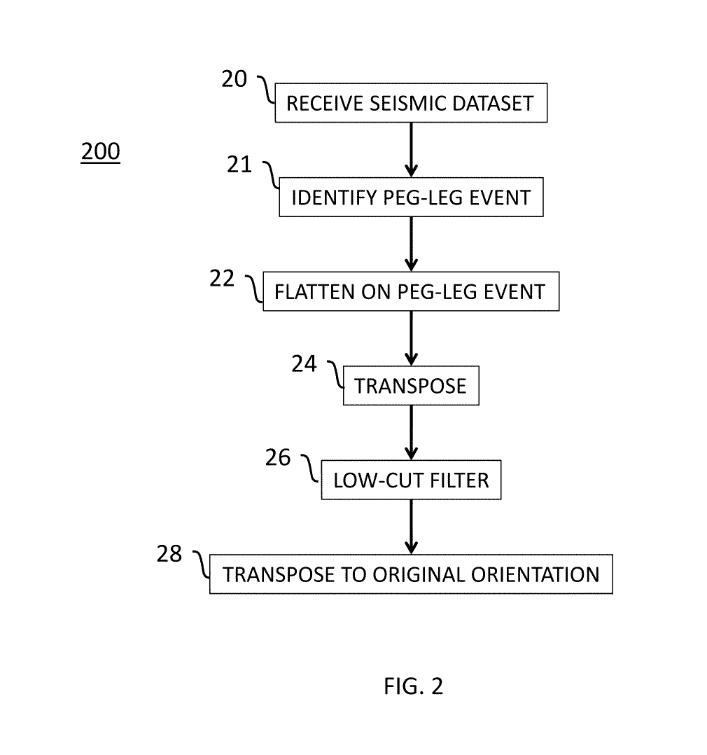

One embodiment of the present invention is shown as method 200 in FIG. 2. At operation 20, a recorded seismic dataset is received. The recorded seismic dataset may be from a seismic survey in a land or marine environment. The recorded seismic dataset may be from a 2-D seismic line or a 3-D seismic volume. The recorded seismic dataset may have been previously processed, including the use of imaging processes such as migration. The recorded seismic dataset will have a first dimension that represents travel time or depth and at least one more dimension that represents geographical space.

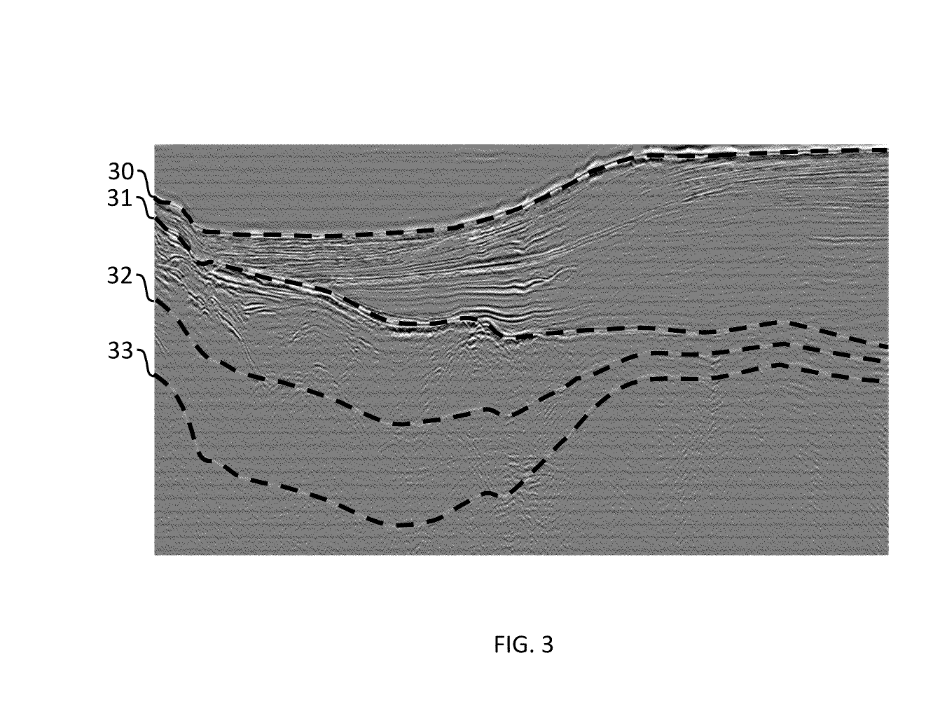

Referring again to FIG. 2, at operation 21 a peg-leg multiple event is identified. This event may have been previously picked on a seismic image during seismic interpretation. Alternatively, it may be identified by calculation of travel times through the subsurface and any water column. One skilled in the art will appreciate that there are many ways to identify a peg-leg event. In addition, there may be more than one peg-leg event in the seismic dataset. This might be caused by multiple bounces of the seismic energy or multiple highly reflective interfaces in the subsurface. FIG. 3 shows an example of a seismic data section with horizons identified on it. The dashed lines show the water bottom 30, the base of high-contrast rock 31, the first peg-leg multiple 32, and the second peg-leg multiple 33. The first peg-leg multiple 32 followed a path that began near the free surface, reflected at the base of high-contrast rock 31, reflected from the free surface, and finally reflected from the water bottom 30 before being recorded. The second peg-leg multiple 33 followed the same path but bounced twice between the free surface and water bottom 30 before being recorded. In this figure, the vertical axis (first axis) is travel time and the horizontal axis is geographic position.

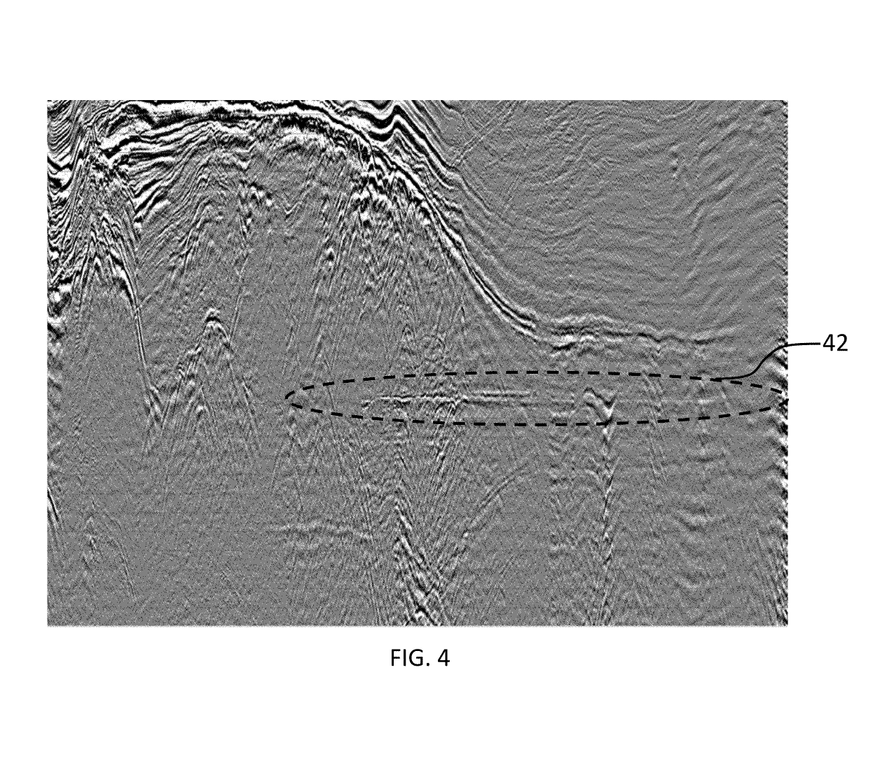

When a peg-leg event has been identified, the seismic dataset can then be flattened on the peg-leg event (see FIG. 2, operation 22). One skilled in the art will be aware that conventional seismic processing platforms possess horizon-flattening tools capable of flattening the seismic dataset so that the identified peg-leg event becomes horizontal (flat). This is illustrated in the example in FIG. 4. The seismic data section in FIG. 4 is the same seismic data section shown in FIG. 3 but it has been flattened on the first peg-leg multiple. The first peg-leg multiple is shown as dashed line 32 in FIG. 3 and inside the oval 42.

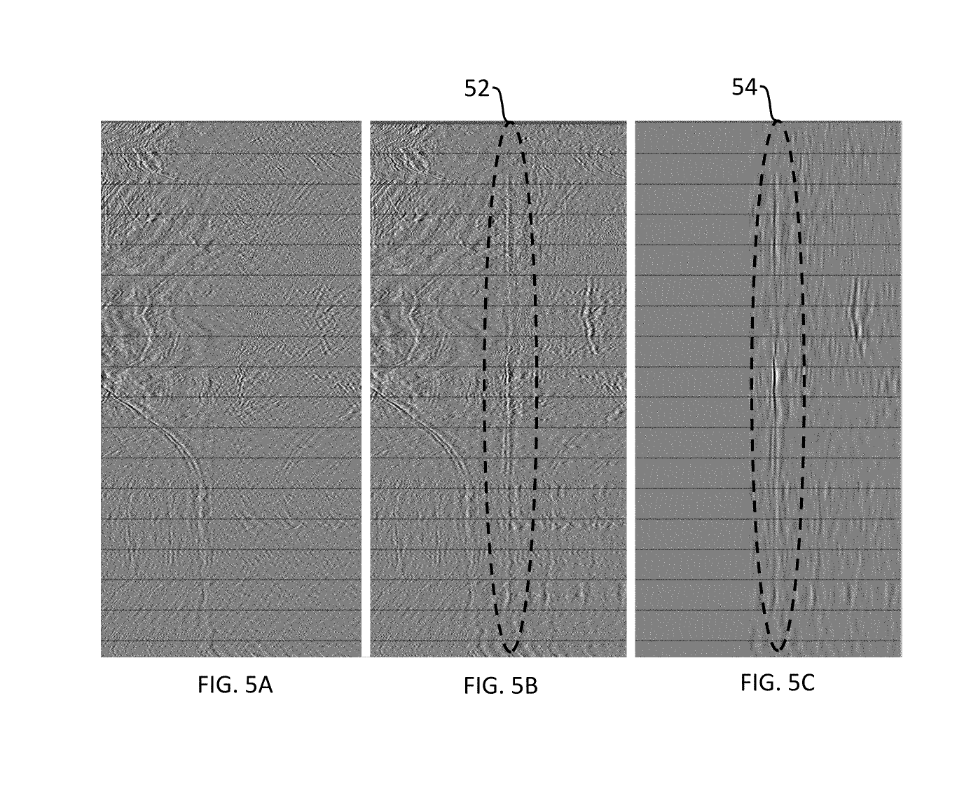

Once the seismic dataset is flattened on the peg-leg event, it is transposed at operation 24. This transposition changes the orientation of the axes of the dataset. The time or depth axis becomes a horizontal axis while the geographic axis becomes the first axis. The effect of this transposition is to make the previously flat peg-leg event into a vertical event, essentially turning it into a very low frequency event along the first axis. This operation is not merely turning the display of the seismic data on its side but rather changing the way the seismic data is stored in the computer memory. Conventional seismic data processing does not transpose seismic datasets due to the large memory requirements and a failure to recognize advantages in changing the orientation. The present invention makes use of recent advances in seismic data handling, such as those in Landmark's SeisSpace®, to perform this transposition. A transposed seismic data section can be seen in FIG. 5B, which indicates the flattened first peg-leg multiple inside the oval 52.

Since the peg-leg energy is now very low frequency energy along the first axis, it can be filtered out of the dataset using a low-cut filter along the first axis at operation 26 in FIG. 2. This filter will attenuate any energy that was made flat during the flattening operation 22. A result of applying this low-cut filter can be seen in FIG. 5A, which is the filtered transposed seismic data section. The difference between the filtered transposed seismic data section in FIG. 5A and the transposed seismic data section in FIG. 5B can be seen in FIG. 5C, which shows that the first peg-leg event in oval 54 has been removed.

After the peg-leg energy is attenuated at operation 26, the filtered transposed seismic dataset can be transposed back to its original orientation. The peg-leg event is now attenuated. The flattening of operation 22 can be reversed to restore the original subsurface structure. If more than one peg-leg event was identified at operation 21, the process may repeat operations 22—28 until all peg-leg events have been attenuated. The result will be a multiple-attenuated seismic dataset that is more suitable for further seismic processing and interpretation, which may allow for improved identification of subsurface hydrocarbon reservoirs.

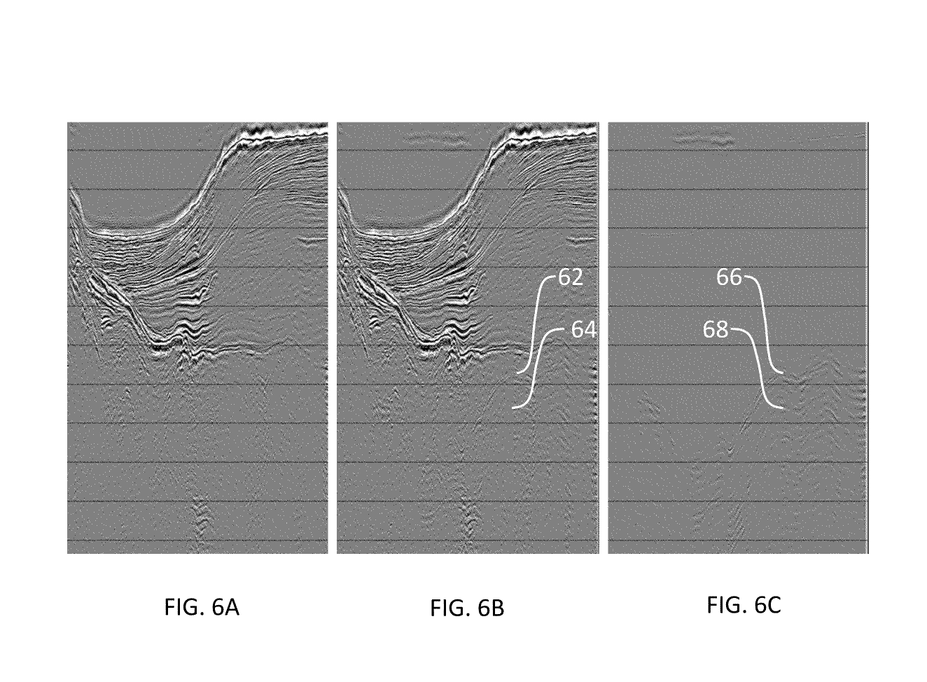

Two more examples of results of method 200 can be seen in FIGS. 6A—6C and FIGS. 7A—7C. In FIG. 6B, a seismic data section is contaminated with a first peg-leg multiple event 62 and a second peg-leg multiple event 64. FIG. 6A is the filtered seismic data section that has undergone method 200. FIG. 6C is the difference of the seismic data sections in FIG. 6A and FIG. 6B and shows the peg-leg energy that has been attenuated at event 66 and event 68. In FIGS. 7A—7C, CRP gathers are shown (first axis is time, horizontal axis is offset). FIG. 7B is a CRP gather from a seismic dataset contaminated with first peg-leg event 72 and second peg-leg event 74. After the seismic dataset has been processed by method 200, the filtered seismic dataset includes the CRP gather in FIG. 7A which has attenuated peg-leg energy. The difference of FIG. 7A and FIG. 7B can be seen in FIG. 7C, which shows that first peg-leg event 76 and second peg-leg event 78 have been removed from FIG. 7A.

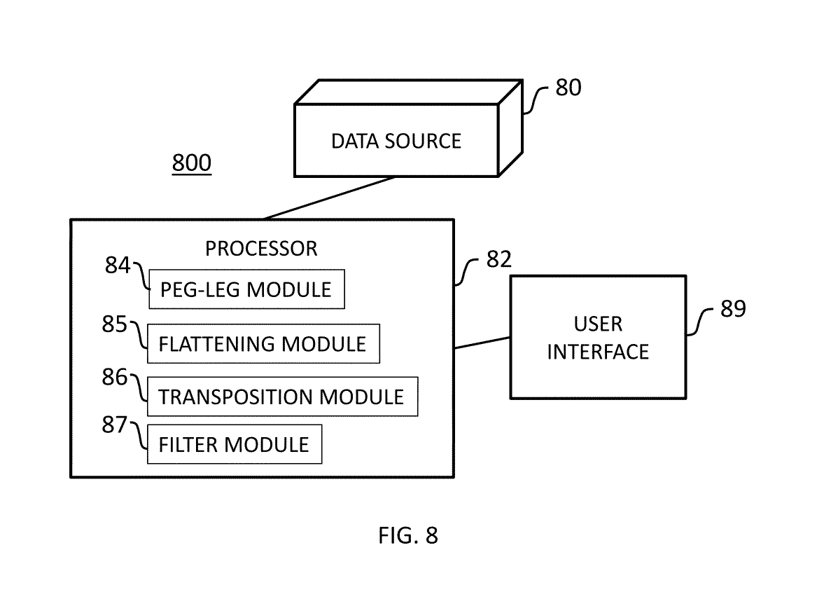

A system 800 for performing the method 200 of FIG. 2 is schematically illustrated in FIG. 8. The system includes a data source/storage device 80 which may include, among others, a data storage device or computer memory. The data source/storage device 80 may contain recorded seismic data and/or synthetic seismic data. The data from data source/storage device 80 may be made available to a processor 82, such as a programmable general purpose computer. The processor 82 is configured to execute computer modules that implement method 200. These computer modules may include a peg-leg module 84 for identifying a peg-leg event, a flattening module 85 for flattening the seismic dataset on the peg-leg event, a transposition module 86 for transposing the seismic dataset to various orientations, and a filter module 87 for applying a low-cut filter. These modules may include other functionality. In addition, other modules such as an interpretation module for identifying subsurface geologic features such as hydrocarbon reservoirs may be used. The system may include interface components such as user interface 89. The user interface 89 may be used both to display data and processed data products and to allow the user to select among options for implementing aspects of the method. By way of example and not limitation, the input seismic data and the multiple-attenuated seismic data computed on the processor 82 may be displayed on the user interface 89, stored on the data storage device or memory 80, or both displayed and stored.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention. In addition, it should be appreciated that structural features or method steps shown or described in any one embodiment herein can be used in other embodiments as well.

What is claimed is:

1. A computer-implemented method for processing seismic data representative of a subsurface volume of interest, the method comprising:
a. receiving, at a computer processor, a seismic dataset that includes peg-leg multiple energy with an original orientation arranged as a first axis representative of either time or depth and at least one other axis representative of a geographic space;
b. identifying at least one peg-leg event in the seismic dataset;
c. flattening, via the computer processor, the seismic dataset on the peg-leg event;
d. transposing, via the computer processor, the seismic dataset so that the one other axis representative of the geographic space becomes the first axis to generate a transposed seismic dataset;
e. filtering, via the computer processor, the transposed seismic dataset with a low-cut filter along the first axis to generate a filtered seismic dataset; and
f. transposing, via the computer processor, the filtered seismic dataset to the original orientation to obtain a multiple-attenuated seismic dataset.

2. The method of claim 1 further comprising using the multiple-attenuated seismic dataset to identify geologic features of the subsurface volume of interest.

3. The method of claim 1 wherein more than one peg-leg event is identified and further comprising repeating steps c through f for each of the more than one peg-leg events.

4. A system for processing seismic data representative of a subsurface volume of interest, the system comprising:
a. a data source containing a seismic dataset;
b. a computer processor configured to execute computer modules, the computer modules comprising:
i. a peg-leg module for identifying at least one event of peg-leg energy in the seismic dataset;
ii. a flattening module for flattening the seismic dataset on the at least one event of peg-leg energy;
iii. a transposition module for transposing the seismic dataset; and
iv. a filter module; and
c. a user interface.

5. The system of claim 3 further comprising an interpretation module for identifying geologic features of the subsurface volume of interest.

6. An article of manufacture including a non-transitory computer readable medium having computer readable code on it, the computer readable code being configured to implement a method for processing seismic data, the method comprising:
a. receiving, at a computer processor, a seismic dataset that includes peg-leg multiple energy with an original orientation arranged as a first axis representative of either time or depth and at least one other axis representative of a geographic space;
b. identifying at least one peg-leg event in the seismic dataset;
c. flattening, via the computer processor, the seismic dataset on the peg-leg event;
d. transposing, via the computer processor, the seismic dataset so that the one other axis representative of the geographic space becomes the first axis to generate a transposed seismic dataset;
e. filtering, via the computer processor, the transposed seismic dataset with a low-cut filter along the first axis to generate a filtered seismic dataset; and
f. transposing, via the computer processor, the filtered seismic dataset to the original orientation to obtain a multiple-attenuated seismic dataset.
